(19) United States
(12) Patent Application Publication
(10) Pub. No.: US 2010/0294971 A1
(43) Pub. Date: Nov. 25, 2010

(54) VALVE DIAPHRAGM

(75) Inventor: Elias Hajjar, Bankstown (AU)

Correspondence Address: SUGHRUE MION, PLLC, 2100 PENNSYLVANIA AVENUE, N.W., SUITE 800, WASHINGTON, DC, 20037, US

(73) Assignee: MICROFLOW INTERNATIONAL PTY LIMITED, Darlinghurst, New South Wales (AU)

(21) Appl. No.: 12/738,206

(22) PCT Filed: Oct. 15, 2008
(86) PCT No.: PCT/AU08/01520

§ 371 Date: Jul. 15, 2010

(30) Foreign Application Priority Data
Oct. 16, 2007 (AU) 2007905678

(51) Int. Cl. F16K 7/12

(52) U.S. Cl. 251/331

(57) ABSTRACT

A valve component (1), formed at least partly of resilient material, including a body portion (2), of generally overall cylindrical shape, a radial recess (3), provided within an end surface of said body portion, and a peripheral flange (5), extending outwardly from said body portion adjacent to said radial recess. The peripheral flange (5) of the valve component (1) is adapted to be secured to a valve casing in a manner such that axial movement of the valve component (1) is permitted between an open position, wherein flow of fluid is permitted between an inlet and an outlet, and, a closed position, wherein the flow of fluid is prevented.

### BACKGROUND OF THE INVENTION

The present invention relates to a diaphragm for a valve which permits movement between open and closed positions, allowing operation of the valve.

### DESCRIPTION OF THE PRIOR ART

The reference in the specification to any prior publication (or information derived from it), or to any matter which is known, is not, and should not be taken as, an acknowledgement or admission or any form of suggestion that that prior publication (or information derived from it) or known matter forms part of the common general knowledge in the field of endeavour to which this specification relates.

The Applicant has hereinbefore designed various valves which have significant advantages over the earlier prior art. Details of the Applicant's prior art valve devices are described in the Applicant's various patents/applications, including International Application PCT/AU1996/00263, and Australian Provisional Patent Application No. 2006905723. The disclosures of these specifications should be considered to be entirely incorporated in this specification, by this reference thereto.

In the Applicant's earlier aforementioned patent applications, there is defined a valve device which includes control chamber, passageways communicating the control chamber with the inlet and outlet ports, and a flow control element within at least one of the passageways. The flow control element effectively controls the flow of fluid within the passageways to thereby control the flow of fluid between the inlet and outlet of the valve device, per se. Utilising these arrangements, as described in the Applicant's aforementioned patent applications, only very microscopic flows, compared with the prior art, are required to control the operation of the valve device.

### SUMMARY OF THE INVENTION

The present invention seeks to provide an improved diaphragm-like valve component over that described in the aforementioned and other prior art patents/applications.

The present invention seeks to provide a diaphragm-like valve component which is able to be utilised in any type of valve including, but not limited, to the valves described in the Applicant's aforementioned patent applications.

In one broad form, the present invention provides a valve component, formed at least partly of resilient material, including:

a body portion, which is of generally overall cylindrical shape;

a radial recess, provided within an end surface of said body portion; and

a peripheral flange, extending outwardly from said body portion adjacent to said radial recess;

wherein, said peripheral flange of said valve component is adapted to be secured to a valve casing in a manner such that axial movement of said valve component is permitted between an open position, wherein flow of fluid is permitted between an inlet and an outlet, and, a closed position, wherein said flow of fluid is prevented.

Preferably, said component is adapted to move between said open and closed positions according to pressure differentials of fluid supplied to each end of said body portion.

Also preferably, said component is normally biased in said closed position, and may deform against its natural resilience by reducing pressure to said end surface having said radial recess provided therein.

Preferably, said end surface having radial recess provided therein defines part of a wall of a control chamber.

Also preferably, pressure of fluid within said control chamber is controlled to consequently permit the movement of said valve component to selectively open and/or close a valve.

Preferably, the valve component further includes a fluid passageway extending between the ends of said substantially cylindrically shaped body portion.

Also preferably, said fluid passageway extends either axially or non-axially through said body portion.

Preferably also, the valve component further includes a flow control element within said fluid passageway.

Also preferably, said fluid passageway extends between a control chamber and an inlet of a valve in which said valve component is installed.

Preferably, said peripheral flange has an enlarged end thereon, which is adapted to be retained within a correspondingly shaped recess in said valve casing.

Also preferably, said flow control element is retained within said fluid passageway by retaining means.

Preferably, said retaining means includes an enlarged end on said flow control element which is adapted to fit within a correspondingly shaped cutout within said valve casing.

Also preferably, the resilient material is rubber.

### BRIEF DESCRIPTION OF THE DRAWINGS

The present invention will become more fully understood from the following detailed description of preferred but non-limiting embodiments thereof, described in connection with the accompanying drawings, wherein:

FIG. 1 illustrates the valve component in accordance with a preferred embodiment of the present invention;

FIG. 2 illustrates the valve component of FIG. 1 installed in a valve;

FIG. 3 details the portion of the valve FIG. 2 containing the valve component of the present invention;

FIG. 4 illustrates an alternatively preferred embodiment of the valve component of the present invention, and;

FIG. 5 illustrates the “deformed” position of the valve component of the present invention.

### DETAILED DESCRIPTION OF PREFERRED EMBODIMENTS

Throughout the drawings like numerals will be used to identify like features, except where expressly otherwise indicated.

The valve component, generally designated by the numeral 1 is preferably formed at least partly of resilient material, such as rubber. The valve component 1 includes a body portion 2 which is substantially cylindrical in shape. A radial recess 3 is provided within one end surface 4 of the cylindrically shaped body portion 2. A peripheral flange 5 extends outwardly from the cylindrically shaped body portion 2 adjacent to the radial recess 3.

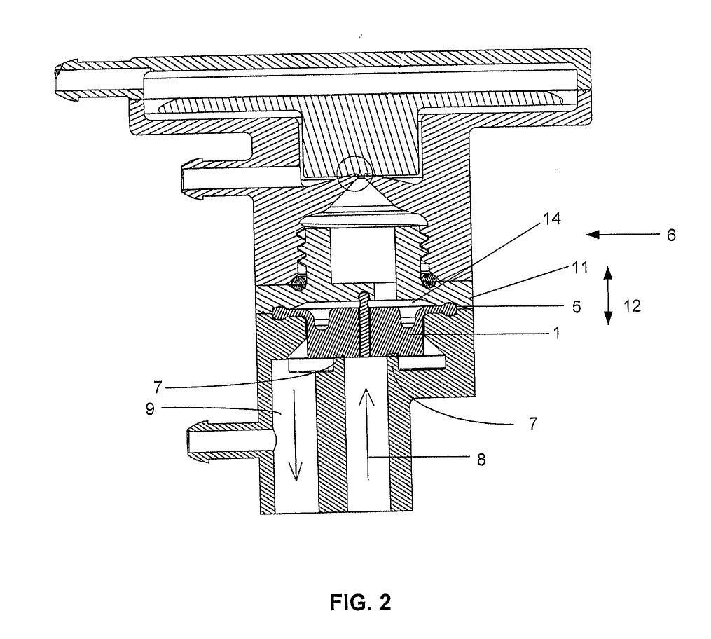

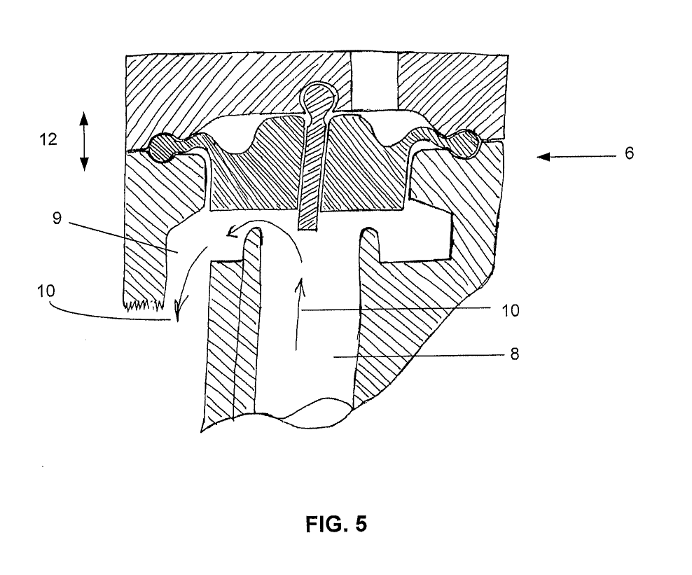

As shown in FIGS. 2, 3 and 4, the valve component 1 may be installed within a valve 6. Depending upon the position of the valve component 1, and specifically, whether or not the valve component 1 rests against the valve seat 7, the valve component moves between an open position, wherein fluid flow is permitted from an inlet 8 to an outlet 9, or, a closed position, wherein fluid flow is prevented. FIGS. 2, 3 and 4 illustrate the valve 6 in its closed position, whilst FIG. 5 illustrates the valve in its open position whereby fluid flow between the inlet 8 and the outlet 9 in the direction of arrows 10 is permitted.

As shown in the drawings, the valve component has a peripheral flange 5 which is adapted to be secured within a valve casing 11 in a manner such that axial movement of the valve component 1 is permitted in the direction of arrows 12. That is, when the valve component 1 rests against seat 7 the valve is closed such that fluid flow is prevented, whilst, when the valve component 1 moves axially upwards and ‘deforms’ to the position shown in FIG. 5, fluid flow is permitted.

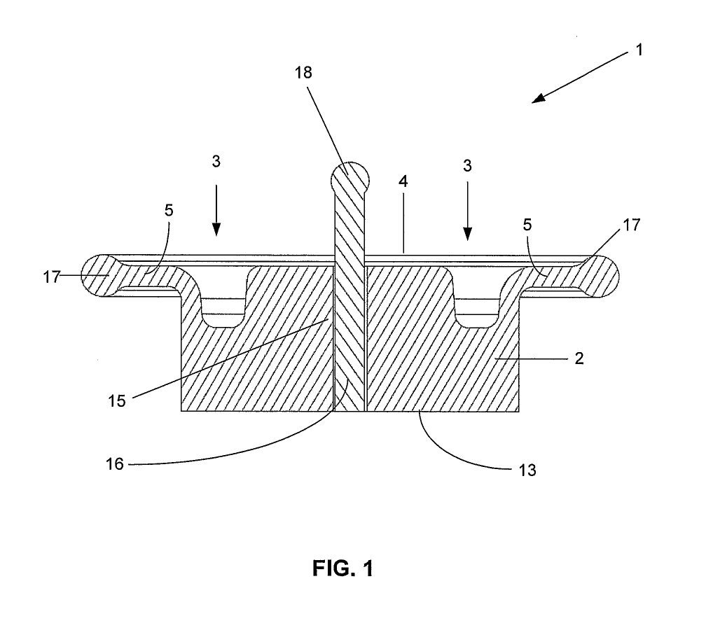

As hereinbefore described with relation to FIG. 1, the valve component 1 of the present invention is formed of a resilient material, such as rubber, and includes a radial recess 3 which permits deformity of the valve component 1 such as shown in FIG. 5 depending upon the pressure at either the upper end 4 or the lower end 13 of the cylindrically shaped body portion 2. Specifically, the relatively thin, flat peripheral portion 5 bends and straightens between the ‘relaxed’ position shown in FIG. 1, and the ‘deformed’ position shown in FIG. 5. The recess 3 minimises ‘stretching’ and deformation as this movement occurs, improving, in particular the durability of the valve component 1 and eliminating the need for a biasing spring as well as keeping, in particular, the flow control element and the fluid passageway relatively undeformed so as the operation of the valve device, per se, is not affected, as the valve device moves up and down.

That is, when the pressure on the upper end 4 is lower than the pressure on the lower end 13 the valve component 1 is deformed to the position shown in FIG. 5 by virtue of the recesses and the peripheral flange 5 connected thereto. When the pressure on end 4 is increased above or equal to the pressure on end 13, the valve member 2 returns, under its normal resilience to the position shown in FIGS. 2, 3 and 4, and the state shown in FIG. 1.

It will therefore be appreciated that the valve component 1 is adapted to move between its open and closed positions according to the pressure differentials of fluid supplied to each end 3 and 13 of the body portion 2. Whilst the particular configuration of the valve component 2 is shown in the drawings, it will be appreciated that the valve component may be alternatively embodied such that the radial recess is provided in the lower portion of the component and/or the peripheral flange may be located at either an upper, lower or intermediate position outwardly of the body portion 2. Additional recesses or notches or the like may be provided to assist in the functional operation of the component. A variation of these factors will vary the normal bias of the valve component 1 in being able to be deformed against its natural resilience by consequently reducing the pressures supplied at various portions of the valve component 1.

In the embodiment shown in the drawings, the upper end surface of the valve component 1 defines part of a wall of a control chamber 14, the operation of which is described in the Applicant's earlier mentioned patent applications.

It will therefore be understood by the persons skilled in the art that the pressure of fluid within the control chamber 14 may be controlled to consequently permit the movement of the valve component 1 to selectively open or close the valve.

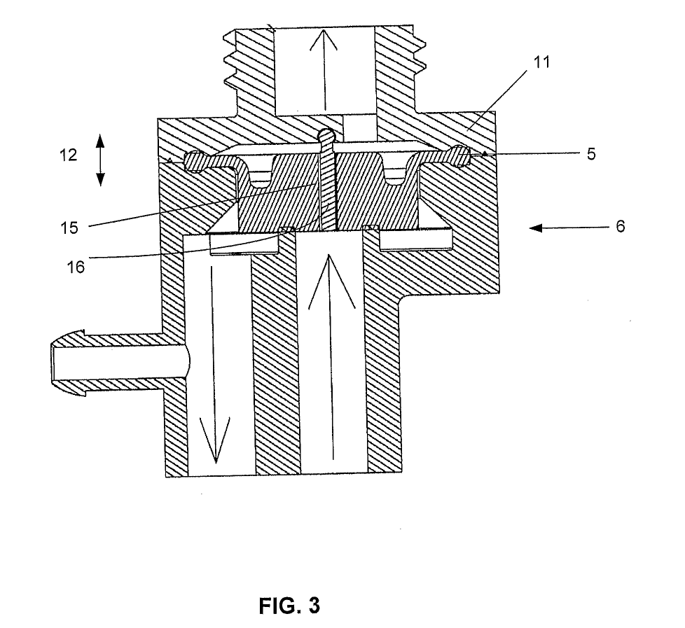

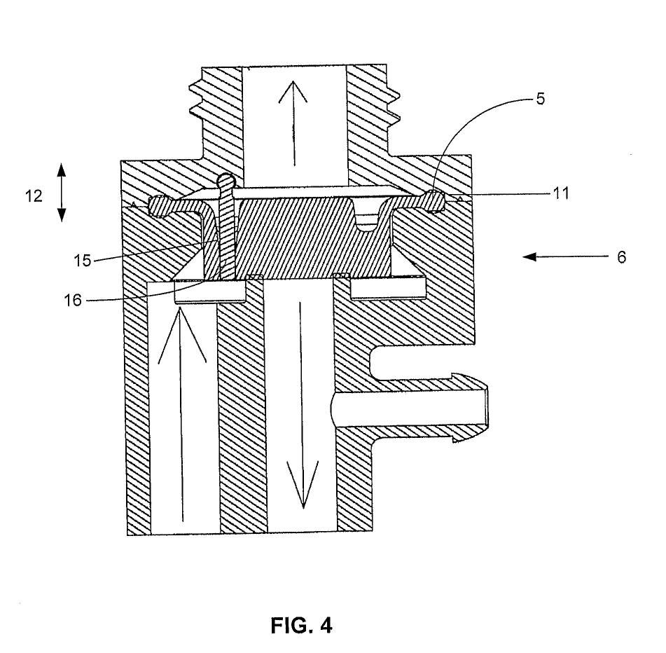

Also shown in the drawings is a fluid passageway 15 which extends between the ends of the substantially cylindrically shaped body portion 2. This fluid passageway may extend either axially (i.e. through the centre) or non-axially through the body portion 2. An axially (centred) passageway is shown in FIG. 3, whilst a non-axially (non-centred) passageway is shown in FIG. 4. Details of the operation of the fluid passageway and the flow control element 16 provided therein are described in the Applicant's aforementioned patent applications, but in effect, the provision of the fluid passageway 15 and flow control element therein permit the operation of the valve with only microscopic flows being required.

It will be seen that the peripheral flange 5 which extends outwardly of the body portion 2 is shown having enlarged ends 17. This allows the valve component 2 to be retained within correspondingly shaped recesses or orifices provided within valve casing 11. The flow control element 16 may likewise be retained within the fluid passageway 15 by an enlarged end 18 adapted to be received within an orifice in the valve casing. Other forms of retaining means for both the valve body 2 and the flow control element 16 may alternatively be used, and such alternate versions will become apparent to persons skilled in the art.

It will be appreciated that the valve component of the present invention which incorporates a radial recess and peripheral flange extending outwardly therefrom allows movement of the valve component when installed in a valve in the direction shown in arrows 12 in a unique manner allowing the inclusion of a passageway 15 and flow control element 16 to be installed therein, enabling functional operation of the device.

It will be understood by persons skilled in the art that the material used is preferably a resilient material, such as rubber or the like. Depending on the ‘hardness’ of the rubber, etc, the resilience of the component may be varied, which will of course, vary the amount of pressure required to deform the component. These factors, amongst others, will be understood to be variable depending on the design requirements in particular situations.

It will be appreciated that variations and modifications to the present invention will become apparent to persons skilled in the art. All such variations and modifications should be considered to fall within the spirit and scope of the invention as broadly hereinbefore described.

1. A valve component, formed at least partly of resilient material, including:
a body portion, which is of generally overall cylindrical shape;
a radial recess, provided within an end surface of said body portion; and
a peripheral flange, extending outwardly from said body portion adjacent to said radial recess;
wherein, said peripheral flange of said valve component is adapted to be secured to a valve casing in a manner such that axial movement of said valve component is permitted between an open position, wherein flow of fluid is permitted between an inlet and an outlet, and, a closed position, wherein said flow of fluid is prevented.

2. A valve component as claimed in claim 1 wherein said component is adapted to move between said open and closed positions according to pressure differentials of fluid supplied to each end of said body portion.

3. A valve component as claimed in claim 2 wherein said component is normally biased in said closed position, and may deform against its natural resilience by reducing pressure to said end surface having said radial recess provided therein.

4. A valve component as claimed in claim 3 wherein said end surface having radial recess provided therein defines part of a wall of a control chamber.

5. A valve component as claimed in claim 4 wherein pressure of fluid within said control chamber is controlled to consequently permit the movement of said valve component to selectively open and/or close a valve,

6. A valve component as claimed claim 1, further including;
a fluid passageway extending between the ends of said substantially cylindrically shaped body portion.

7. A valve component as claimed in claim 6, wherein said fluid passageway extends either axially or non-axially through said body portion.

8. A valve component as claimed in claim 6, further including:
a flow control element within said fluid passageway.

9. A valve component as claimed in claim 6, wherein;
said fluid passageway extends between a control chamber and an inlet of a valve in which said valve component is installed.

10. A valve component as claimed in claim 1, wherein said peripheral flange has an enlarged end thereon, which is adapted to be retained within a correspondingly shaped recess in said valve casing.

11. A valve component as claimed in claim 8, wherein said flow control element is retained within said fluid passageway by retaining means.

12. A valve component as claimed in claim 11, wherein said retaining means includes an enlarged end on said flow control element which is adapted to fit within a correspondingly shaped cutout within said valve casing.

13. A. valve component as claimed in claim 1, wherein said resilient material is rubber.
